(19) United States
(12) Patent Application Publication
(10) Pub. No.: US 2023/0156472 A1
(43) Pub. Date: May 18, 2023

(54) Transmitting Unit and Receiving Unit for Transmitting and Receiving Data Packets

(71) Applicant: Bayerische Motoren Werke Aktiengesellschaft, Muenchen (DE)

(72) Inventors: Martin Kuemmel, Fahrenzhausen (DE); Gerald Conrad, München (DE)

(21) Appl. No.: 17/919,626

(22) PCT Filed: May 7, 2021
(86) PCT No.: PCT/DE2021/100423

§ 371 Date: Oct. 18, 2022

(30) Foreign Application Priority Data
May 18, 2020 (DE) 10 2020 113 451.7

(51) Int. Cl. H04W 12/106; H04W 12/06

(52) U.S. Cl. CPC H04W 12/106; H04W 12/06

(57) ABSTRACT

A transmitting unit for transmitting data packets which contain useful information and corresponding receiving unit. The transmitting unit is configured to transmit multiple data packets successively. The transmitting unit is configured to generate and transmit a data packet with combined authentication information for a predefined number of transmitted data packets or for data packets which are transmitted in a predefined time period. The combined authentication information provides an authentication of the data packets of the predefined number of transmitted data packets or of the data packets that are transmitted in a predefined time period.

The present application is the U.S. national phase of PCT Application PCT/DE2021/100423 filed on May 7, 2021 which claims priority of German patent application No. 102020113451.7 filed on May 18, 2020, which is incorporated herein by reference in its entirety

### TECHNICAL FIELD

The present disclosure relates to a transmitting unit for transmitting data packets. The present disclosure invention further relates to a receiving unit for receiving data packets, as well as a system having a transmitting unit and a receiving unit.

In various applications, such as in vehicles, data buses are used to enable data transmission between different units, for example in control loops of a vehicle. Such a data or communication bus, which is used by multiple units, can be, for example, a CAN bus or a FlexRay bus. The transfer of data is usually secured in order to ensure a secure transfer with regard to functional safety (i.e. the error-free transfer of data, referred to as Safety) as well as with regard to manipulation (referred to as Security). In this regard, it has so far been common also to transfer a number of bytes of security data in addition to the transferred useful data. For example, the transfer can be secured by end-to-end protection.

Since protection must be provided with regard to both safety and security, this results in a high bus load and a high latency, which is a drawback in particular in fast control loops, i.e. control loops that require a fast response and therefore a fast data transfer. Furthermore, there are systems in which the use of transmitted data can only take place after a verification or authentication of the respective data. Again, this results in high latency when using the transferred data.

There exists a need, therefore, to enable data to be transmitted over a data bus, in particular in a vehicle, with reduced latency and a reduced bus load.

### SUMMARY

The above-stated need, as well as others, are achieved by a transmitting unit, a receiving unit for receiving data packets, and/or a system having a transmitting and receiving unit per at least the embodiments disclosed herein.

The proposed transmitting unit is configured to transmit data packets containing useful information. The data packets are transmitted in particular via a data bus, for example a CAN bus in a motor vehicle. The transmitting unit is configured to transmit multiple data packets in succession. The multiple data packets can contain useful data or useful information from the same control function. This means that the data refer to the same control loop within the motor vehicle.

In order to reduce latency in transmission and thus in the control loops compared to previous systems, the transmitting unit is designed to generate and transmit a data packet with combined authentication information for a predefined number n of transmitted data packets or for data packets that are transmitted in a specified time period. The combined authentication information provides authentication of the n data packets or of the data packets transmitted during the predefined time period.

This means that the transmitting unit can transmit the data packets containing the useful data continuously, rather than having to waiting for a certain quantity of data packets to be present in order to generate and transmit authentication information for these data packets.

The transmitting unit can generate the combined authentication information depending on the type of underlying authentication principle after transmitting the data packets, or even before or during the transmission. In any case, the generation of the combined authentication information is independent of the time when the data packets are transmitted.

Instead of a predefined number of data packets, a predefined time period can be used. In the first case, the combined authentication information is generated for the predefined number of data packets. In the second case, the combined authentication information is generated for the data packets that are transmitted within the predefined time period.

The authentication information is information that is used to detect manipulation of the data or corruption of the data due to a data transmission error. This increases the security of the entire system, since it can be detected whether the transmitted data packets are the original data packets or are manipulated or incorrect data packets. In this way, the transmission can be secured with regard to both safety and security.

Furthermore, the transmitting unit does not need to generate individual authentication information for each data packet and send it directly with the data packet. This reduces the data traffic on the data bus. Instead, the transmitting unit can transmit combined authentication information for multiple data packets as a single information item that relates to multiple data packets. Furthermore, the transmitting unit can transmit the data packets to which the authentication information refers immediately and transmit the associated combined authentication information only after a certain number n of data packets, or even during this process. This also reduces the latency, because on the one hand the total data traffic is reduced and on the other hand it is not necessary to wait to transmit the data packets.

The predefined number n of transmitted packets, or the predefined time period, can be determined based on an acceptable error tolerance time. In doing so it can be determined how long an incorrect or manipulated value can be accepted by the system (or the units that use the data packets) before an unsafe or unacceptable state occurs. This can vary depending on the content of the data packets or the affected control loops.

Furthermore, the predefined number or the predefined time period can be dynamically adjusted. For example, the error tolerance time can vary depending on the driving situation. In this case, the number n or the predefined time period can also be dynamically modified by the transmitting unit.

According to one embodiment, the transmitting unit is configured to transmit the combined authentication information as a separate data packet. This has the advantage that this data packet can be treated separately.

In one embodiment it is also possible to transmit the data packets with the useful information and the data packets with the associated combined authentication information on different data buses. This can further enhance security because if a data bus is manipulated or a transmission error occurs, another data bus may be unaffected.

The authentication information can contain one or more features of the predefined number n of data packets or the data packets transmitted during the predefined time period. The one or more features are used to authenticate the respective data packets individually or as a whole. Since only a single item of combined authentication information is transmitted for multiple data packets, the number of authentication information items transmitted is reduced, and therefore the bus load and the latency accordingly.

The one or more features can be features of the last n transmitted data packets with useful data or of the data packets with useful data of the predefined time period. Depending on the authentication principle, features of the n data packets to be transmitted can also be used. The features can be, for example, a hash value of the sum of the n values, a checksum of the sum of the n values, an average of the last n values, a minimum value and a maximum value of the last n values, a standard deviation of the last n values, or similar. The values are the values of the respective data packets or the useful data contained therein.

The use of a minimum and maximum value limits the safe value range, i.e. the value range in which the value of the useful data may vary without giving cause to assume a manipulation or a transmission error has occurred. This has the additional advantage that the authentication information can be checked in the receiving unit even if individual data packets have been lost due to a fault.

If, for example, a minimum value and a maximum value are used, it is possible to generate and transmit the combined authentication information before transmitting the n data packets if it is known which maximum value and which minimum value the data packets will have.

The data packet containing the combined authentication information can contain its own separate authentication information. This further increases the security of the entire system, since a manipulation of the combined authentication information or a corruption of the data due to a transmission error can also be detected. The authentication information of the combined authentication information can be, for example, a hash value or a checksum.

In accordance with another aspect, a receiving unit for receiving data packets containing useful information is proposed. The receiving unit is configured to receive multiple data packets successively from a transmitting unit, such as the one described above, and to forward them for usage. The receiving unit can forward the received data packets to any of the units within an overall system, in particular a vehicle. In particular, the data packets, in particular the useful information contained therein, can be used to implement specific control processes in a vehicle or to control control loops.

In order to be able to detect manipulation or corruption due to a transmission error in the data packets or the useful information, the receiving unit is configured to receive a data packet with combined authentication information that contains authentication information of a predefined number n of data packets or of data packets that were sent within a predefined time period. The receiving unit can then use the combined authentication information to authenticate the n data packets already received and forwarded for usage and to carry out further steps based on a result of the authentication.

The time of receipt of the combined authentication information and the receipt of the data packets can be independent of each other, as also described above in connection with the transmission. Only the authentication itself requires at least one data packet and the combined authentication information. In any case, the received data packets can already be forwarded for use, independently of the receipt of the combined authentication information.

This has the advantage compared to previous systems that, on the one hand, the processing latency is reduced since the data packets with useful information can be forwarded for use even before they are authenticated, and, on the other hand, that only a single combined authentication information item needs to be received, which can reduce the data traffic. In particular, the data packets can be received in a motor vehicle via a data bus, such as a CAN bus or similar. The useful information can be information used to control different units or control loops within a motor vehicle. Such a control unit can be, for example, an electric drive or a steering control system.

As already explained above, the data packets with useful information and the data packets with the associated combined authentication information can be transmitted on different data buses.

According to one embodiment, the receiving unit is configured, as an additional step, to inform the transmitting unit about the result of the authentication and/or to inform a unit that uses the data packets about the result of the authentication. If the receiving unit detects any manipulation or corruption due to a data transmission error, the receiving unit can return this information to the transmitting unit. Based on this, the transmitting unit can, for example, re-transmit the already transmitted data with the corresponding combined authentication information. Furthermore, the receiving unit can also inform the unit that uses the data packets of any manipulation or corruption caused by a data transmission error. Appropriate measures can then be taken in the unit, such as entering a safe state. Furthermore, the receiving unit can also inform a third unit (e.g. a shut-off device) about a manipulation or corruption due to a data transmission error, in order to initiate the transfer into the safe state.

The receiving unit and the additional unit that uses the data packets, or the third unit, can be implemented as physically separate units. Alternatively, two or more units may be integrated into a single unit and may exist only as logically separate components.

As explained above, the combined authentication information may contain its own separate authentication information. The receiving unit can then be configured to authenticate the combined authentication information using its own authentication information. In this way, it is possible to detect not only a manipulation or corruption of the data packets containing the useful information, but also a manipulation or corruption of the combined authentication information in these data packets. This further increases the security of the overall system.

The combined authentication information can contain information about the predefined number n of data packets or the predefined time period. This means that the combined authentication information can contain information about how many data packets are authenticated by itself. Based on this information, the receiving unit can then authenticate the predefined number n of data packets or the data packets during the predefined time period.

According to a further aspect, a system is proposed for transmitting and receiving data packets, in particular in a motor vehicle, wherein the system has a transmitting unit as described above and a receiving unit as described above.

For example, the system can be a motor vehicle and/or a control loop of a motor vehicle. Such a control loop can be, for example, an electric drive or a steering control system. With an electric drive, for example, one aim is to perform comfort control by reducing drive train vibrations. Such control requires a short cycle time of a few milliseconds (1-5 ms). In this context, a cycle time means the intervals at which the data packets with useful information are sent. A dangerous vehicle response only occurs after a lengthy period of incorrect control, in particular after 20-100 ms, so that authentication of the data packets is only necessary after a certain number of data packets with useful information. Another example is the steering control system. In this case, a control system must be designed in such a way that the haptic steering sensation is pleasant for the user. This requires a short cycle time, i.e. an interval of 1-5 ms between the data packets. A dangerous vehicle response, i.e. a response that would lead to an unsafe state of the vehicle, would only occur after 20-50 ms in the event of errors in the control of the steering system, for example due to manipulation or corruption of data. Here also, the useful data cycle, i.e. the interval between the data packets with useful information, and the error tolerance time, i.e. the time above which an authentication, i.e. detection of a manipulation, is absolutely necessary, are therefore clearly different.

This difference can be used to determine, on both the transmit and receive sides, how many, or over what period, data packets can be transmitted, received and used before authentication is required and therefore combined authentication information must be generated, transmitted, and received.

The system proposed here, with a transmitting unit and a receiving unit, can optimize the transmission of data packets with useful information, or their authentication, so that the useful data can be transmitted without the need to secure each individual data packet. The combined authentication information contains security-relevant properties of the useful data and transmits them in a separate message. These properties or features can be used to detect security-relevant corruptions or manipulations of the useful data or their data packets and to trigger appropriate measures at the receiver. However, the message that contains the combined authentication information only needs to be transmitted often enough that a robust evaluation can be ensured within the error tolerance time. Based on this, it is possible to determine the predefined number n of data packets, or the predefined time period, that will be transmitted before the combined authentication information is transmitted. Since the combined authentication information is only transmitted for a certain number n of data packets or for a certain period of time, the data load on the bus is reduced.

According to a further aspect a method for transmitting data packets containing useful information is proposed, wherein multiple packets are transmitted successively. The method comprises the following steps: generating and transmitting a data packet with combined authentication information for a predefined number of transmitted data packets or for data packets which are transmitted in a specified time period, wherein the combined authentication information provides an authentication of the data packets of the defined number of transmitted data packets or of the data packets which are transmitted in a specified time period.

According to a further aspect a method is proposed for receiving data packets containing useful information, wherein multiple packets are received successively from a transmitting unit and forwarded for usage. The method comprises the following steps: receiving a data packet with a combined authentication information item containing authentication information of a predefined number of data packets or of data packets transmitted within a predefined time period, authenticating the data packets already received and forwarded for usage by using the combined authentication information, and carrying out further steps based on a result of the authentication.

The embodiments and features described for the proposed transmitting unit or receiving unit also apply correspondingly to the proposed methods.

Furthermore, a computer program product is proposed which contains program code that is designed to cause the method as described above to be executed on a computer.

A computer program product, such as a computer program means, can be provided or supplied as a storage medium, such as a memory card, USB stick, CD-ROM, DVD, or else in the form of a downloadable file from a server to a network. This may be effected, for example, in a wireless communication network by the transmission of a corresponding file with the computer program or the computer program means.

Further possible implementations also comprise combinations of features either described previously or in the following in relation to the exemplary embodiments, which are not explicitly mentioned. A person skilled in the art will also be able to add individual aspects as improvements or additions to each basic form of the embodiments described herein.

Further advantages and advantageous embodiments are specified in the description, the drawings and the claims. In particular, the combinations of features specified in the description and in the drawings are purely exemplary, so that the features can also be combined individually or present in other ways.

In the following, aspects will be explained in more detail by reference to exemplary embodiments shown in the drawings. The exemplary embodiments and the combinations shown in the exemplary embodiments are purely exemplary and are not intended to define the scope of protection. The latter is defined solely by the attached claims.

### BRIEF DESCRIPTION OF THE DRAWING

FIG. 1 shows a schematic block diagram of a system for transmitting and receiving data packets.

### DETAILED DESCRIPTION

In the following, identical or functionally equivalent elements are labeled with the same reference signs.

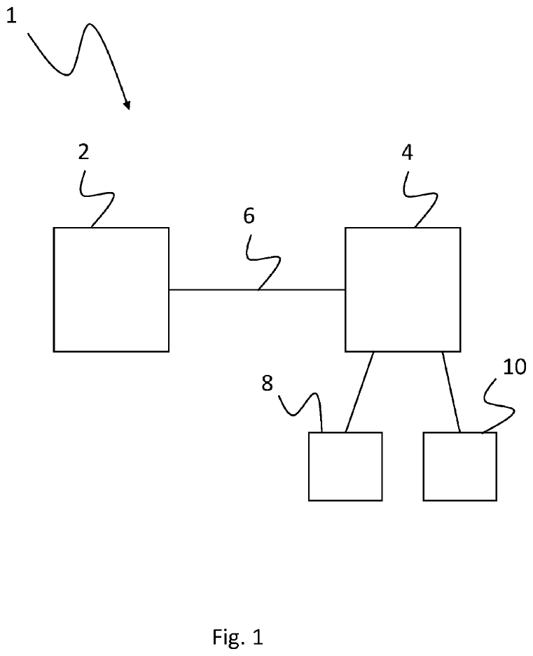

FIG. 1 shows a system 1 for transmitting and receiving data packets.

The system 1 can be a control loop in a motor vehicle, for example. Such a control loop can be, for example, a control system of an electric drive or a steering control system. Other control loops are also possible.

The system 1 has a transmitting unit 2 and a receiving unit 4 to transmit data required for the control loop via a data bus 6, for example a CAN bus. In order to ensure that the transmitted data has not been manipulated or corrupted due to a transmission error, and thus to increase the security of the system 1, authentication information items of the transmitted data packets can be transmitted from the transmitting unit 2 to the receiving unit 4.

However, frequent transmission of authentication information, in particular the transmission of authentication information with every data packet, increases data traffic on the data bus 6 and thus increases the latency. The calculation and decryption of the authentication information creates an additional computing load on the transmitting side 2 and the receiving side 4. This also increases the signal propagation times, i.e. latencies, that lead to a signal propagation time or dead time that is difficult to overcome by control techniques, in particular in fast control loops.

In order to improve the detection of manipulations of data packets used to control such control loops and to reduce the data traffic on the communication bus 6 in the system 1, the transmitting unit 2 is configured to send a message or data packet with combined authentication information for a specific predefined number n of data packets that contain useful information for the control system, or for data packets transmitted within a predefined time period. The combined authentication information contains information about the last n data packets, where n is the predefined number, or about the data packets transmitted during the predefined time period.

For the sake of simplicity, the following assumes only a predefined number n of data packets. However, the description also applies to a predefined time period.

For example, the combined authentication information can be a minimum value and a maximum value of the data packets. Other forms of authentication information, such as a hash value, are also possible.

The advantage of sending the combined authentication information is that, rather than having to send separate authentication information for each data packet, only a single authentication information item is sent. The combined authentication information can then be used to detect a manipulation or corruption of the n data packets. This reduces the number of data items on the communication bus 6.

The receiving unit 4 can in turn receive the n data packets and forward them directly for further processing and usage, for example to a unit 8. This means that the data packets can be used before they are authenticated. This reduces the processing latency on the receiver side 4.

If the receiving unit 4 then receives the combined authentication information from the transmitting unit 2, the receiving unit 4 can authenticate the n data packets belonging to the combined authentication information. If it should turn out that one or more of the data packets has obviously been manipulated or corrupted, the receiving unit 4 can forward this information to the unit 8 that uses the data packets. Appropriate measures can then be taken in the unit 8, such as transferring into a safe state. This ensures the security of the system 1 while at the same time reducing the latency of the system 1.

This takes advantage of the fact that the error tolerance time for control loops of the system 1 is greater than the cycle time for the transmission of the data packets. This means that multiple potentially manipulated or corrupted data packets may be transmitted and used before a security-critical situation of the system 1 occurs. Therefore, n data packets can be transmitted and used and only thereafter is the corresponding authentication information of the n data packets used as combined authentication information.

The receiving unit 4 can also transfer the result of the authentication to the transmitting unit 2. Based on this, the transmitting unit 2 can, for example, re-transmit the already transmitted data with the corresponding combined authentication information. Furthermore, the receiving unit 4 can also inform a third unit 10 (e.g. a shut-off device) about any manipulation or corruption due to a data transmission error, in order to initiate the transfer into the safe state.

The receiving unit 4 and the other units 8, 10 can be implemented as physically separate units, as shown in FIG. 1. Alternatively, two or more of the units 4, 8, 10 may be integrated into a single unit and only exist as logically separate components.

The described system thus makes it possible to detect a manipulation of data packets and at the same time reduce the latency and the data traffic in the system.

### REFERENCE SIGNS

1 system

2 transmitting unit

4 receiving unit

6 data bus

8, 10 additional units

1.-10. (canceled)

11. A transmitting unit for transmitting data packets which contain useful information, wherein the transmitting unit is configured to:
transmit multiple data packets successively, and
generate and transmit a data packet with combined authentication information for a predefined number of transmitted data packets or for data packets which are transmitted in a predefined time period,
wherein the combined authentication information provides an authentication of the data packets of the predefined number of transmitted data packets or of the data packets that are transmitted in a predefined time period.

12. The transmitting unit as claimed in claim 11, wherein the transmitting unit is configured to transmit the combined authentication information as a separate data packet.

13. The transmitting unit as claimed in claim 12, wherein the authentication information contains one or more features of the predefined number of data packets.

14. The transmitting unit as claimed in claim 11, wherein the authentication information contains one or more features of the predefined number of data packets.

15. The transmitting unit as claimed in claim 14, wherein the one or more features includes a minimum and maximum value, a hash value, a checksum, an average value, and/or a standard deviation of the transmitted data packets.

16. The transmitting unit as claimed in claim 12, wherein the data packet containing the combined authentication information contains authentication information for authenticating the combined authentication information.

17. The transmitting unit as claimed in claim 11, wherein the data packet containing the combined authentication information contains authentication information for authenticating the combined authentication information.

18. A receiving unit for receiving data packets containing useful information, wherein the receiving unit is configured to:
receive multiple data packets successively from a transmitting unit and to forward said data packets for usage,
receive a data packet with a combined authentication information item containing authentication information of a predefined number of data packets or of data packets transmitted within a predefined time period,
authenticate the data packets already received and forwarded for usage using the combined authentication information, and
carry out further steps based on a result of the authentication.

19. The receiving unit as claimed in claim 18, wherein the receiving unit is further configured to inform the transmitting unit about the authentication and/or to inform a unit that uses the data packets about the authentication.

20. The receiving unit as claimed in claim 19, wherein:
the combined authentication information contains separate authentication information, and
the receiving unit is configured to authenticate the combined authentication information using the separate authentication information.

21. The receiving unit as claimed in claim 18, wherein:
the combined authentication information contains separate authentication information, and
the receiving unit is configured to authenticate the combined authentication information using the separate authentication information.

22. The receiving unit as claimed in claim 21, wherein:
the combined authentication information contains information about the predefined number or the predefined time period, and
the receiving unit is configured to authenticate the predefined number of data packets or the data packets of the predefined time period.

23. The receiving unit as claimed in claim 18, wherein:
the combined authentication information contains information about the predefined number or the predefined time period, and
the receiving unit is configured to authenticate the predefined number of data packets or the data packets of the predefined time period.

24. A system for transmitting and receiving data packets comprising:
a transmitter configured to transmit multiple data packets successively, generate and transmit a data packet with combined authentication information for a predefined number of transmitted data packets or for data packets which are transmitted in a predefined time period,
wherein the combined authentication information provides an authentication of the data packets of the predefined number of transmitted data packets or of the data packets that are transmitted in a predefined time period; and
a receiver configured to receive the multiple data packets.

25. The system as claimed in claim 24, wherein the authentication information contains one or more features of the predefined number of data packets.

26. The system as claimed in claim 25, wherein the one or more features includes a minimum and maximum value, a hash value, a checksum, an average value, and/or a standard deviation of the transmitted data packets.

27. The system as claimed in claim 25, wherein the receiver is configured to:
receive the multiple data packets successively from the transmitter and to forward said data packets for usage,
receive the data packet with the combined authentication information item containing authentication information for the predefined number of data packets or the data packets transmitted within a predefined time period,
to authenticate the data packets already received and forwarded for usage using the combined authentication information, and
to carry out further steps based on a result of the authentication.

28. The system as claimed in claim 27, wherein the receiver is further configured to inform the transmitter about the authentication and/or to inform a unit that uses the data packets about the authentication.

29. The system as claimed in claim 27, wherein:
the combined authentication information contains separate authentication information, and
the receiver is configured to authenticate the combined authentication information using
the separate authentication information.
